(19) United States
(12) Patent Application Publication
(10) Pub. No.: US 2016/0112352 A1
(43) Pub. Date: Apr. 21, 2016

(54) Method and Device for Real-Time Conversations of Participants and Comments with Each Other

(71) Applicant: National Tsing Hua University, Hsin Chu City (TW)

(72) Inventors: Shan-Hung WU, Hsinchu (TW); Meng-Ren CHEN, Taichung City (TW); Yie-Chieh HSU, Yilan City (TW)

(21) Appl. No.: 14/642,767

(22) Filed: Mar. 10, 2015

(30) Foreign Application Priority Data
Oct. 16, 2014 (TW) 103135878

(51) Int. Cl. H04L 12/58

(52) U.S. Cl. CPC H04L 51/04; H04L 51/36

(57) ABSTRACT

A method for real-time conversations and comment with each other in a mobile device comprises the following steps. In the step (a), it activates a communication module of real-time conversations and comment with each other of a first mobile device. In the step (b), it performs a matching process for a user of the first mobile by a server. In the step (c), it provides a topic of chat for the user of the first mobile device for conversations by using the communication module of real-time conversations and comment with each other or by using the server. In the step (d), the user of the first mobile device transmits a first message to the successfully matched user of a second mobile device and makes comments for a second message from the user of the second mobile device.

### CROSS-REFERENCE TO RELATED APPLICATIONS

This application claims the benefit of TAIWAN patent application No. 103135878, filed Oct. 16, 2014.

### TECHNICAL FIELD

The present invention relates to an internet based conversations between individuals, and more particularly, to a method, device or system for real-time conversations of participants and comments with each other.

### BACKGROUND OF RELATED ART

With the recent development of electronic devices and communication technologies, such as smart phones, portable devices spread rapidly. In addition to the stationary terminal device (e.g. PC), portable device can also be used to develop a variety of techniques to provide a text message or a service of chat.

Internet chat rooms have been in existence for some time. In general there are two types of chat rooms, private and public. In public chat rooms, anyone can join the chat room to discuss issues during any time that the chat room is active. In a public chat room, an individual typically locates the chat room and jumps into the conversation if it is appealing to the individual. The individual is able to simply listen in (i.e. view all comments as they are posted in the room) or the individual may join in by posting a comment. In general, there is no way to prevent an undesirable participant from joining in the conversation, possibly wasting the other participants' time. In private chat rooms, on the other hand, it is possible to prevent undesirable participants from joining a conversation. To join a private chat room, one typically needs a password that is disseminated by one or more of the current participants. In this way, a participant who starts a chat room is able, to some extent, to limit other participants from joining by giving the password to only those individuals they desire to join. Internet chat rooms are also fixed in the sense that they are typically pre-associated with a general topic. Such Internet chat rooms generally do not provide users with the ability to dynamically create a conversation with other users directed to current media content the users may be currently viewing. In particular, there is no ability to control access based on what is being said.

In addition to internet chat rooms, with the development of network technology, Instant Message (IM) has become the most typical method for online communication. At present, for instant message, it can build one to one communication, but also can create an IM group or discussions with other users in a chat room. That is, communication software or system is able to provide for users utilizing an electronic device for chatting or discussing matter. However, in the conventional communication software or system, its main function or purpose is to provide a communication for messages or chat for feelings of contact between friends, or make new friends. The communication software is not for skills of communication or chat between the user and unfamiliar people or strangers.

Based-on shortcomings of methods of the prior arts, the invention provides a newly method and system of real-time conversations to enhance communication, chat and social skills between the user and unfamiliar people or strangers.

### SUMMARY

An object of the present invention proposes a method and a system for real-time conversations of participants and comments with each other.

According to one aspect, the present invention proposes a method and a system for real-time conversations of participants and comments with each other, by matching randomly, limited time of chat, providing a topic or a situation, to practice chatting with a stranger.

According to another aspect, a method for real-time conversations of participants and comments with each other via electrical devices, comprising: (a) activating a communication module for real-time conversations of a first electrical device; (b) performing a matching of a first user of the first electrical device by a server; (c) providing a topic of chat or a situation by the communication module for real-time conversations or the server for chatting of the first user of the first electrical device; and (d) transmitting a first message of matching successfully to a second electrical device from the first electrical device, and commenting a second message transmitted by the second electrical device.

In one aspect, the method further comprises a step of making a total comment for the second message by the first electrical device after the step (d).

In another aspect, the method further comprises a step of receiving a total comment for the first message by the first electrical device after the step (d). The method further comprises a situation displayed by the first electrical device as matching successfully after the step (b). The situation is determined by the communication module for real-time conversations. The situation is one of conditions of the matching. The situation is created by a number of pictures or texts. The first user can simulate practice of chat by the situation. The first electrical device and the second electrical device comprise a computer, a tablet computer, a personal digital assistant (PDA), a cellular phone, or a smart phone.

According to another aspect, an electrical device capable of performing the following steps, the following steps, comprising: (a) activating a communication module for real-time conversations of the electrical device; (b) receiving a message of matching by a server for a user of the electrical device; (c) creating a topic of chat or a situation by the communication module for real-time conversations or receiving the topic of chat or the situation by the server for chatting of the user of the electrical device; and (d) transmitting a first message of matching successfully to a second electrical device, and commenting a second message transmitted by the second electrical device.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a system for real-time conversations and comments with each other according to one embodiment of the invention;

FIG. 2 illustrates a client with a communication module for real-time conversations according to one embodiment of the invention;

FIG. 3 illustrates a process flow for real-time conversations of participants and comments with each other according to one embodiment of the invention;

FIG. 4 illustrates an operation flow for real-time conversations of participants and comments with each other according to one embodiment of the invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The present invention proposes an application for real-time conversations of participants and comments with each other, the application can be loaded into a device or apparatus, such as a computer, a tablet computer, a personal digital assistant (PDA), a cellular phone, or a smart phone, etc., and allows users to match each other anonymously, randomly or by specified conditions, for communicating to chat in a period of time. And, both of users can make a corresponding comment (good or bad) for the reply comment of other user's statement (sentence), and show the comment at the end of chat. The comment includes such as noughts and crosses for statement, the overall rating, a judgment for statement, etc., but not limited to the above items. Communication skills and chat skills for a user with not familiar persons are thereby enhanced.

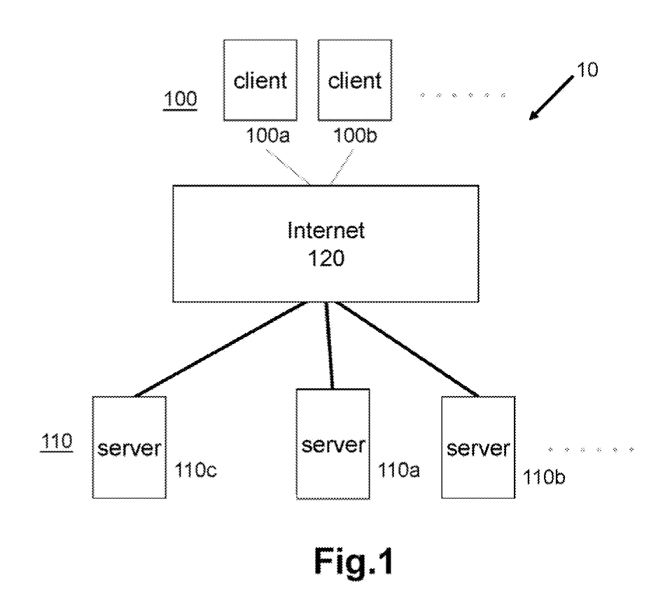

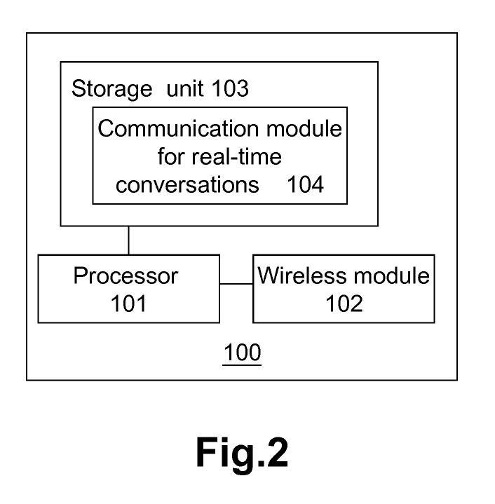

As shown in FIG. 1, it shows a system for real-time conversations and comments with each other according to one embodiment of the invention. In FIG. 1, the system 10 includes clients 100, messaging servers 110 and a communication network 120. For example, client 100 is an electronic device, such as a computer, a tablet computer, a personal digital assistant (PDA), a laptop, a cellular or a smart phone. Each of the clients 100 includes a processor 101, a wireless module 102 and a storage unit 103, wherein the wireless module 102 and the storage unit 103 are coupled to the processor 101, shown in FIG. 2. In one embodiment, an application for real-time conversations of participants and comments with each other can be loaded into the cline 100, for example stored in the storage unit 103. In this system, the clients 100a, 100b and other clients are electrically connected to the messaging servers 110a, 110b and other servers via the communication network 120, such as internet or other communication network. It should be noted that more than one messaging server 100 can be used in the system, and the messaging servers 110a, 110b and other servers may be used to transmit messages of chat or topics of chat, and other server 110c providing additional functionality except transmitting messages of chat. These servers 110 may also be connected to the clients 100 directly, over the internet 120.

For example, the wireless module 102 is a linking unit response for communicating with the server 110 wirelessly over the internet 120. In one embodiment, the linking unit includes a wired linking unit or a wireless linking unit.

In one embodiment, each of the clients 100 includes a communication module for real-time conversations 104. In one embodiment, the communication module for real-time conversations 104 is an application which may be loaded providing for a user. For example, the communication module for real-time conversations 104 is stored into the storage unit 103 of the client 100.

In one embodiment, a special application software can be downloaded into the client 100 as the communication module for real-time conversations 104. The downloading approach may be performed over a wired network, a wireless transmission or a storage media (compact disk or flash drive) by downloading or copying. In one embodiment, the communication module for real-time conversations 104 of the present invention may be obtained by wireless downloading from a trading platform of wireless applications store, which may be stored into the client 100. Therefore, the communication module for real-time conversations 104 of the present invention may be as a downloaded application software. As the application software is downloaded to store into the client 100, the client 100 may provide the function for the real-time conversations via performing of the application software, to achieve the purpose of real-time conversations and comments with each other.

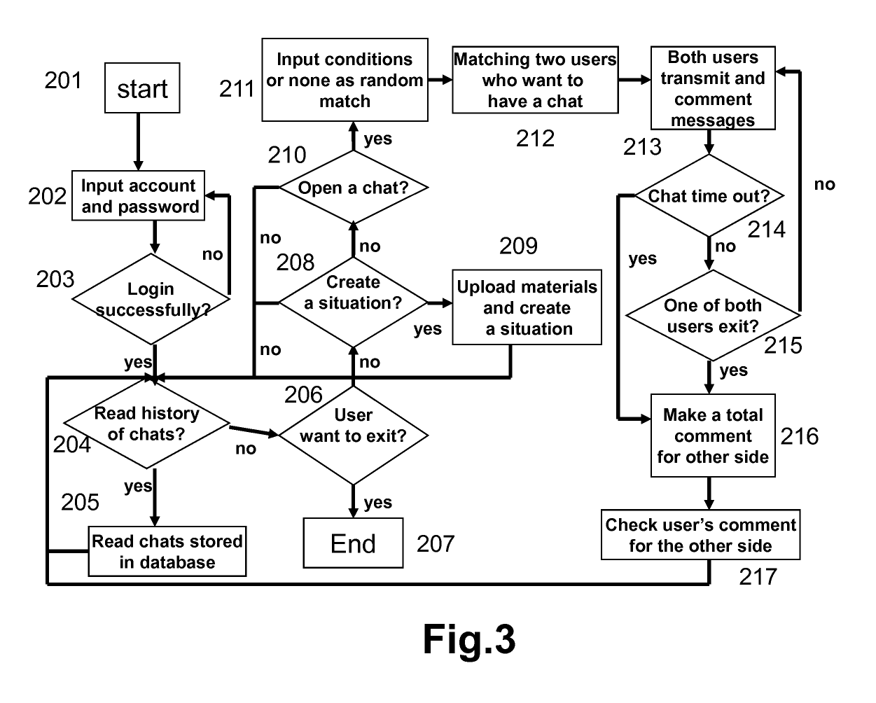

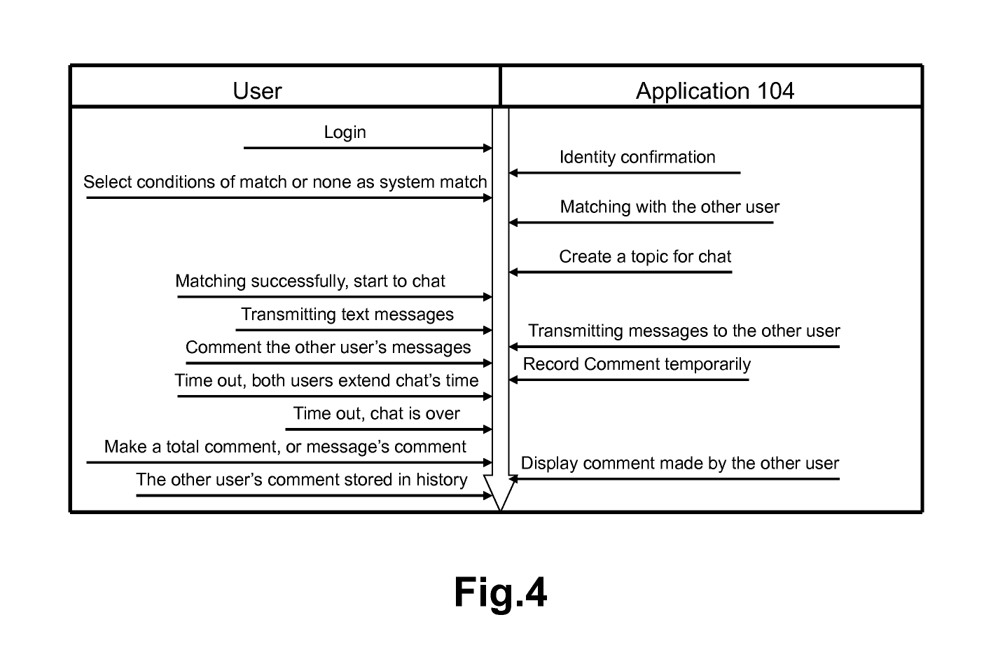

As shown in FIG. 3, it shows a process flow of real-time conversations and comments with each other according to one embodiment of the invention. First, in step 201, it strikes up start of real-time conversations and comments. As mentioned above, the communication module (application software) for real-time conversations 104 may be stored into memory or storage unit of the portable device. In this step, the communication module (application software) for real-time conversations 104 is started up. Then, in step 202, user's account and password are inputted. In this step, the user inputs user's account and password in the client 100. Next, the communication module (application software) 104 is logged in, as shown in FIG. 4. Followed by, in step 203, it determines whether user's login is successfully or not. In this step, user's identity confirmation is performed in the application 104, as shown in FIG. 4. If user's identity is confirmed to be correct in the application 104, then login successfully; otherwise, back to the step 202, again inputting user's account and password. In another embodiment, user's identity confirmation is performed in the server 110. Subsequently, in step 204, it determines whether history of chats is read or not. If the decision is positive (yes), then proceeding to next step 205, reading chats information stored in database. In one embodiment, database is stored in the server 100. That is, the user may review history of chats to help oneself look back learning. The step 204 and 205 may be repeatedly for facilitating to read more history of chats or read repeat. Then, if the decision is negative (no) in the step 204, then proceeding to next step 206. In the step 206, it determines whether the user want to exit from the application 104 or not. If the decision is positive (yes) in the step 206, then terminating the application 104; otherwise, proceeding to step 208, determining whether the user creates a situation or not. If the decision is positive (yes) in the step 208, then it can upload materials and create a situation in step 209. That is, the user can create a suitable situation for conversation's practice. If the decision is negative (no) in the step 208, then proceeding to next step 210. In the step 210, it determines whether the user want to open a chat or not.

In the present invention, a situation includes for example “chat situation” or “simulated scenario”. “Chat situation” or “simulated scenario” refers to the materials presented by some information to allow user for pregnant immersive effect. The materials include images, text, narration, but not limited to the above items. For example, the user seeing a store decoration of Starbucks will evoke memory he had a cup of coffee in the store, as if engaged in the situation at the time. As the user realizes environment settings in the device that can have the same effect. For example, a user reads a text, “you sit on chair in the door, wearing suit, a former interviewer opens the door and walks out slowly, you got to straighten tie, entered the room”, directly or indirectly allowing user to know yourself in the situation, in order to understand their own role (the interviewer).

If the decision is negative (no) in the step 210, then back to the step 204, determining whether the user want to read a history of chats or not. If the decision is positive (yes) in the step 210, then proceeding to step 211. In the step 211, a user inputs conditions of match or none as random match. In this step, the user selects conditions of match or waits to automatically match by the system without selecting conditions of match, as shown in FIG. 4. For example, the user of the client 100 may be matched by the server 110. Users may be matched anonymously by random or specified conditions. Mechanism of anonymity is facilitated to assure freedom of comments, and reduce burden caused by the comments. Next, in step 212, two users of clients 100 who want to have a chat are matched. In this step, in the application program 104, the user is matched with the other users, and generates a topic of chat for reference, as shown in FIG. 4. In another embodiment, the topic of chat may be provided by the server 110. After the matching is successful, the two users of clients 100 can start to chat, as shown in the FIG. 4.

In one embodiment, when matching successfully, the user enters a situation which can be determined by the application 104 or to be as one of the conditions of match of the other users. The situation can be created by a number of pictures or texts, etc., but not limited to the above items. The situation can be offered by the application 104, uploaded by the user or provided by other sources. With this situation (scenario), the user can simulate practice of chat, either peer or inferior roles, such as: accosting to a stranger in coffee shop, conducting interview in the company, etc., but not limited to the above mentioned.

In one embodiment, time for a chat can be set a predetermined time, and two users communicated to chat and comment with each other within a predetermined time. Then, in step 213, both users can transmit and comment messages transferred there-between. For example, a text message desired to pass to second user is inputted by first user, for example, in the application 104, and the text message is transmitted to the second user. Then, the second user's messages are commented by the first user, and the comments are recorded or stored temporarily in the application 104, as shown in FIG. 4. That is, both users can comment statements (text messages) with each other to give the reply comments. For example, the comment includes noughts and crosses for statement to appraise whether the statement is something wrong, the overall rating (evaluation) in order to determine the overall impression.

Next, after a period of time to chat, in step 214, it determines whether time of chat is out. In this phase, both users can choose to extend chat's time, or end the chat (chat is over), as shown in FIG. 4. Then, in step 215, it confirms whether one of the two users exit or not. If the decision is positive (yes) in the step 215, then proceeding to next step 216, make a total (general) comment for the other user. If the decision is negative (no) in the step 215, then return to step 213. That is, in the step 214, after a period of time of chat, both users choose to extend chat's time without ending the chat, then back to the step 213, and both users continue to send messages and comment messages.

Moreover, if the decision is positive (yes) in the step 214, then proceeding to the step 216. In this phase, the user makes a total (general) comment for content of chat, or message's comment, as shown in FIG. 4. Subsequently, in step 217, it checks user's comment for the other side. In the application 104, a user of the first client 100a receives total comment for the messages transmitted from the second client 100b of the other user, and display the total comment made by the other user, as shown in FIG. 4. That is, when chat is over, both users can obtain the total comment form opposite side. The other user's comment can be stored in database (history), and the user can read or cancel the content of comment, as shown in FIG. 4. For example, following to the step 204 and 205, the user can read and review content of the other user's comment stored in database (history).

In summary, difference between application of real-time conversations and comments with each other of the present invention and other instant messaging software randomly matching may refer to table 1. The application of real-time conversations and comments with each other of the present invention highlights statements of chat of the other user and gives reference and feedback of some communication skills to the other side. Under unknown with each other and confidential self-identity (anonymity), reviewers and commentators have been more freedom of comments, in order to enhance skills of accosting and communication of user. In addition, users can also do exercises of situational simulation, so that communication exercises can be closer to practical life. Furthermore, the users can select objects of match according to their own wishes or by the system, enabling the user to exercise more effective, to improve skills of communication and chat.

TABLE 1

| | | | | Application of |
|---|---|---|---|---|
| | Facebook | Azar | Line | the invention |
| Property of | Instant message | Video on demand | Instant message | Instant message, |
| Software | | | | random match |
| Anonymity | No | Yes | No | Yes |
| Buddy lists | Added by favorable | Added by | Almost known | None added |
| | objects | favorable | friends | items and |
| | | objects of | | function |
| | | video's chat | | |
| Video chat | Yes | Yes | Yes | No |
| Matching | No | Yes | No | Yes |
| function | | | | |
| Topic of | Self-setup | Self-setup | Self-setup | Provided by |
| chat | | | | system or user |
| Comment | No | No | No | Yes |
| for | | | | |
| chat | | | | |
| Record for | No | No | No | Yes |
| comment | | | | |
| Main | Feelings of contact | Make new friends | Feelings of | Enhance |
| object | | | contact | communication |
| | | | | and social skills |

Method for real-time conversations and comments with each other of the present invention has the following advantages:
1. Comparing to conventional communication software, the invention provides a concept of chatting for stranger, by anonymity of self-identity and matching randomly to reach the purpose of chatting for stranger;
2. Providing topic of chat by the system, and updating topic of chat at any time, topic of chat may be provided by mobile phone's company or by networking company;
3. Comprising with currently available systems of chat (e.g., Line, Facebook . . . etc.) and methods, providing a differentiated business value
4. Utilizing communication system and networking (internet) system, matching randomly to practice chat, based-on comments with each other to obtain their own evaluation of chat, to improve communication, chat and social skills between the user and unfamiliar people or strangers; prior arts lack of such concept of the invention.

It will be understood that the above descriptions of embodiments are given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A method for real-time conversations of participants and comments with each other via electrical devices, comprising:
(a) activating a communication module for real-time conversations of a first electrical device;
(b) performing a matching of a first user of said first electrical device by a server;
(c) providing a topic of chat or a situation by said communication module for real-time conversations or said server for chatting of said first user of said first electrical device; and
(d) transmitting a first message of matching successfully to a second electrical device from said first electrical device, and commenting a second message transmitted by said second electrical device.

2. The method of claim 1, further comprising a step of making a total comment for said second message by said first electrical device after said step (d).

3. The method of claim 1, further comprising a step of receiving a total comment for said first message by said first electrical device after said step (d).

4. The method of claim 1, wherein a situation is displayed by said first electrical device as matching successfully after said step (b).

5. The method of claim 4, wherein said situation is determined by said communication module for real-time conversations.

6. The method of claim 4, wherein said situation is one of conditions of said matching.

7. The method of claim 4, wherein said situation is created by a number of pictures or texts.

8. The method of claim 4, wherein said first user can simulate practice of chat by said situation.

9. The method of claim 1, wherein said first electrical device comprises a computer, a tablet computer, a personal digital assistant (PDA), a cellular phone, or a smart phone.

10. The method of claim 1, wherein said second electrical device comprises a computer, a tablet computer, a personal digital assistant (PDA), a cellular phone, or a smart phone.

11. An electrical device capable of performing the following steps, said following steps comprising:
(a) activating a communication module for real-time conversations of said electrical device;
(b) receiving a message of matching by a server for a user of said electrical device;
(c) creating a topic of chat or a situation by said communication module for real-time conversations or receiving said topic of chat or said situation by said server for chatting of said user of said electrical device; and
(d) transmitting a first message of matching successfully to a second electrical device, and commenting a second message transmitted by said second electrical device.

12. The device of claim 11, wherein said followings steps further comprises a step of making a total comment for said second message by said electrical device after said step (d).

13. The device of claim 11, wherein said followings steps further comprises a step of receiving a total comment for said first message by said electrical device after said step (d).

14. The device of claim 11, wherein a situation is displayed by said electrical device as matching successfully after said step (b).

15. The device of claim 14, wherein said situation is determined by said communication module for real-time conversations.

16. The device of claim 14, wherein said situation is one of conditions of said matching.

17. The device of claim 14, wherein said situation is created by a number of pictures or texts.

18. The device of claim 14, wherein said user can simulate practice of chat by said situation.

19. The device of claim 11, wherein said electrical device comprises a computer, a tablet computer, a personal digital assistant (PDA), a cellular phone, or a smart phone.

20. The device of claim 11, wherein said second electrical device comprises a computer, a tablet computer, a personal digital assistant (PDA), a cellular phone, or a smart phone.
